(19) United States
(12) Patent Application Publication
(10) Pub. No.: US 2024/0102587 A1
(43) Pub. Date: Mar. 28, 2024

(54) FLOATING HOSE SEGMENT AND SYSTEM OF FLOATING HOSE SEGMENTS

(71) Applicant: Dunlop Oil & Marine Ltd., Pyewipe (GB)

(72) Inventors: Simon Bishop, Beverley (GB); Paul Staton, Grimsby (GB); Divarshan Sivakumar, Lincoln (GB)

(73) Assignee: Dunlop Oil & Marine Ltd., Pyewipe (GB)

(21) Appl. No.: 18/253,776

(22) PCT Filed: Nov. 20, 2020
(86) PCT No.: PCT/EP2020/082885

§ 371 Date: May 20, 2023

(51) Int. Cl. F16L 11/133; F16L 33/01; F16L 39/02; G01M 3/04

(52) U.S. Cl. CPC F16L 11/133; F16L 33/01; F16L 39/02; G01M 3/04; F16L 2201/30

(57) ABSTRACT

Illustrated and described is a floating hose segment (4) with an inner hose element (14) which has a first outer surface (22) which faces away from a line region (16), an outer hose element (24) which has a second inner surface (26) which delimits an interior space through which the inner hose element (14) extends, and a second outer surface (28) which faces outward away from the inner hose element (14), and a communication device (46) which is adapted to transmit information directly or indirectly to a central control device (54), wherein at least one sensor device (42) is provided which is adapted so as to be capable of detecting the presence of at least one substance in the region between the first outer surface (22) and the second inner surface (26), wherein the at least one sensor device (42) is linked to the communication device (46) such that information relating to the presence of the at least one substance between the first outer surface (22) and the second inner surface (26) can be transmitted to the communication device (46), and wherein the communication device (46) is adapted to transmit the information relating to the presence of the at least one substance between the first outer surface (22) and the second inner surface (26) to the central control device (54). A floating hose system is moreover described.

The present invention relates to a floating hose segment and to a system of such floating hose segments.

Floating hoses are designed in such a way that they can float on the surface of water, wherein they are used to join a buoy to a tanker such that, for example, oil can be pumped from the buoy to the ship, or the other way round, from the ship to the buoy, wherein the buoy is joined in turn to a further line which joins the buoy to a reservoir for the oil. Floating hoses of this type are used in particular in the open ocean such that the tankers can already be loaded and unloaded there and there is no need for the ships to call at a port.

However, the following technical problems exist with such floating hose systems. If a segment of a floating hose system has a leak, this can cause oil to pass from inside the floating hose into the surroundings, which entails serious consequences for the environment and is again to be avoided at all costs. If, on the other hand, water penetrates inside the floating hose, this can cause the floating hose to sink such that it then has to be recovered at considerable expense.

In the meantime, floating hose segments have often been designed in such a way that they have an inner hose element which is designed in the shape of a hose and delimits a line region through which a fluid such as, for example, oil can be conveyed. The inner hose element is surrounded by an outer hose element which is likewise designed in the shape of a hose and has a second inner surface which faces the inner hose element. A region in which liquid can collect is formed between the first outer surface of the inner hose element and the second inner surface of the outer hose element. The hose elements are here not necessarily dimensioned such that a free volume is permanently formed between the hose elements. Rather, it is also conceivable that the hose elements normally are in contact with each other but are not fixedly joined to each other such that, because of the elastic properties of the hose elements, a free volume is formed only when, because of a leak, either oil from inside or salt water from outside penetrates into this region either in the inner hose element or the outer hose element.

If a leak does in fact exist either in the outer hose element or the inner hose element, the respective liquid penetrates first into the region which is formed between the hose elements and collects there. If the quantity of liquid there is too large, the respective further hose element also tears such that a complete leak then occurs and the line region is then joined to the surroundings such that, for example, oil passes into the surroundings from the line region.

Against this background, the object of the present invention is now to provide a floating hose segment which identifies leaks in the floating hose segment at an early point in time before the line region becomes joined to the surroundings.

According to a first aspect of the present invention, this object is achieved by a floating hose segment with
an inner hose element which has the shape of a hose and has a first inner surface which delimits a line region through which a fluid such as, for example, oil can be conveyed, and a first outer surface which faces away from the line region,
an outer hose element which has the shape of the hose and has a second inner surface which delimits an interior space through which the inner hose element extends, and a second outer surface which faces outward away from the inner hose element, and
at least one communication device which is adapted to transmit information directly or indirectly to a central control device,
wherein the inner and the outer hose element extend between a first end and a second end of the floating hose segment,
wherein at least one sensor device is provided, wherein the at least one sensor device is arranged and adapted so as to be capable of detecting the presence of at least one substance in the region between the first outer surface and the second inner surface,
wherein the at least one sensor device is linked to the communication device such that information relating to the presence of the at least one substance between the first outer surface and the second inner surface can be transmitted to the communication device, and
wherein the communication device is adapted to transmit the information relating to the presence of the at least one substance between the first outer surface and the second inner surface to the central control device.

The floating hose segment according to the invention has an inner hose element which has an inner surface which delimits the actual line region through which a fluid such as, for example, oil is conveyed. The inner hose element is surrounded by an outer hose element, wherein the first outer surface which is provided on the inner hose element, and the second inner surface which is formed on the outer hose element, face each other and delimit a region into which liquid can pass when either the outer hose element or the inner hose element have a leak. A leak in the outer hose element initially causes water, in particular salt water, to pass into the region. If, conversely, the inner hose element has a leak, oil passes into the region between the hose elements.

According to the invention, at least one sensor device is provided which is designed to detect the presence of a substance in the region between the first outer surface and the second inner surface. In particular, in an advantageous configuration of the present invention, the sensor device can be designed to detect hydrocarbons and/or salt water.

Moreover, a communication device which, on the one hand, is linked to the at least one sensor device and, on the other hand, can transmit information directly or indirectly to a central control device is provided on the floating hose segment according to the invention. The link between the communication device and the sensor device can be designed as wired or wireless. However, because the emitter device has to be supplied with energy, it can be advantageous to provide a wired link.

If, in the structure according to the invention of the floating hose segment, a leak occurs either in the outer hose element or in the inner hose element, either oil emerging from the line passes into the region between the first outer surface and the second inner surface and can be detected by the sensor device, or salt water passes from outside into the region between the surfaces and can also be detected by the sensor device.

In both cases, the sensor device can then transmit a corresponding signal to the communication device that the respective liquid is present in the region. The communication device can in turn further process this signal and communicate it to a central control device such that the latter can trigger an alarm.

In the configuration according to the invention, it is advantageous that the alarm is already triggered when a leak has occurred in just one of the two hose elements, which in the case of a leak in the inner hose element has not yet caused oil to pass into the surroundings. Neither does a leak only in the outer hose element already cause the floating hose segment to sink. Therefore, the alarm signal is generated already at an early stage before the actual damage happens. In the case of the floating hose segment according to the invention, an alarm is therefore already triggered at an early point in time and there is enough time to take measures which prevent greater damage.

In a preferred configuration of the present invention, the floating hose segment moreover has a first connection element at the first end and a second connection element at the second end, wherein each connection element here has a coupling section for joining to a further connection element and a pipe section which extends away from the coupling section. At each connection element, the inner hose element is fastened to a first section of the pipe section and the outer hose element is fastened to a second section of the pipe section, wherein the second section is closer to the coupling section than the first section.

In this configuration of the present invention, connection elements which in particular have flanges at their free ends are provided at the ends of the floating hose segment such that two connection elements can be fixedly joined to each other and a plurality of hose elements can thus be coupled to one another. The connection elements furthermore have pipe sections onto which the ends of the hose elements can be pushed, wherein the inner hose element is pushed onto, and joined to, one section of the pipe section which is further away from the coupling section than the section of the pipe section onto which the second outer hose element is pushed and at which it is joined to the pipe section. The two hose elements forming the floating hose segments are thus fixedly joined to the connection element. Furthermore, this enables the sensor device to be fastened to the pipe section, and to be precise in the region between the sections to which the hose elements are fastened. The sensor device then adjoins the region which is formed between the first outer surface and the second inner surface and into which liquid can penetrate either from outside or from inside. This structure thus enables the sensor device to be fastened directly to the connection element.

In a further advantageous configuration of the invention, when a connection element is used with two sections, at the pipe section, to which the hose elements are fastened, a plurality of sensor devices can be fastened between these sections around the circumference of the pipe section, which further increases the sensitivity of the system for leaks.

According to a further preferred embodiment, a circumferential rib can be provided on the pipe section of the connection elements, which rib is situated between the first section and the second section, i.e. between the regions in which the inner hose element and the outer hose element are joined to the pipe section. This enables a particularly reliable join between the connection element, on one hand, and the hose elements, on the other hand. Furthermore, the sensor device can be fastened to the circumferential rib, which further simplifies mounting.

In a further preferred configuration, in the case of a floating hose segment which has connection elements at its ends, the at least one sensor device can be linked to the communication device via a cable which runs between the outer hose element and the second section of the pipe section and/or runs through the second hose element. In the variant in which the cable runs between the outer hose element and the second section of the pipe section, the mounting of the cable is simplified, whilst in the second variant in which the cable runs through the second hose element, leakages in the region of the cable at the second pipe section can be avoided.

It is furthermore preferred if the communication device is accommodated in a recess in the outer hose element, wherein the recess extends from the second outer surface, i.e. from the outside of the floating hose segment, into the outer hose element. In such a case, the cable leading to the sensor device can extend through the second hose element to the recess. Such an arrangement enables the communication device to be assembled simply, wherein it is nevertheless attached in a protected fashion.

It is furthermore preferred if the communication device is configured so that information relating to the presence of the questionable substance in the region between the first outer surface and the second inner surface can be transmitted wirelessly to a further communication device or to the central control device. This makes it possible to transmit information on a possible leak either initially to the communication device of the nearest floating hose segment and from there onward to the central control device or directly to this unit.

It is furthermore preferred if the inner hose element has an inner carcass and/or the outer hose element has an outer carcass. The stability of the hose elements is further increased by the carcasses, which improves the overall stability of the floating hose segment.

According to a further aspect of the present invention, the object above is achieved by a floating hose system comprising a multiplicity of floating hose segments according to the preceding configurations, wherein the first and second ends of different floating hose segments are joined to each other in such a way that they form a chain of floating hose segments which extends between a first chain end and a second chain end.

It is further preferred here if the system moreover has a buoy which is arranged at one of the chain ends and has the central control unit.

The present invention will be explained below with reference to drawings showing only preferred exemplary embodiments of the present invention, wherein

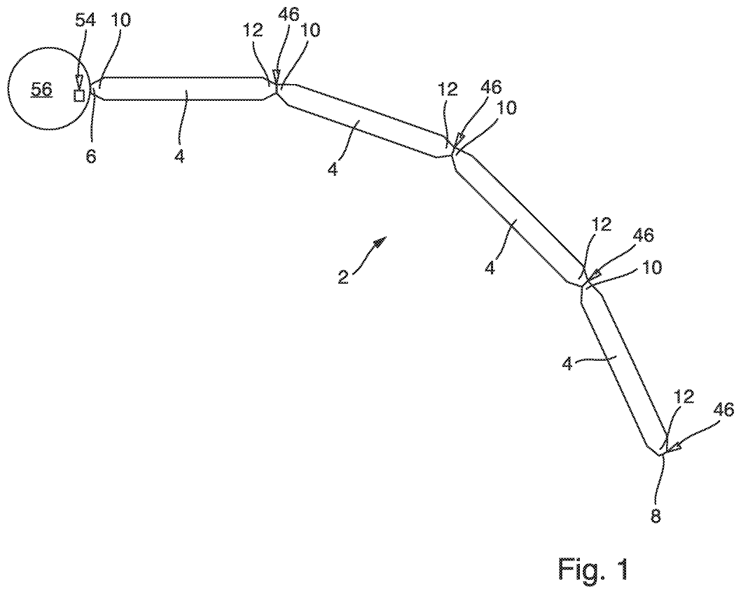

FIG. 1 is a schematic illustration of a preferred exemplary embodiment of a floating hose system according to the invention,

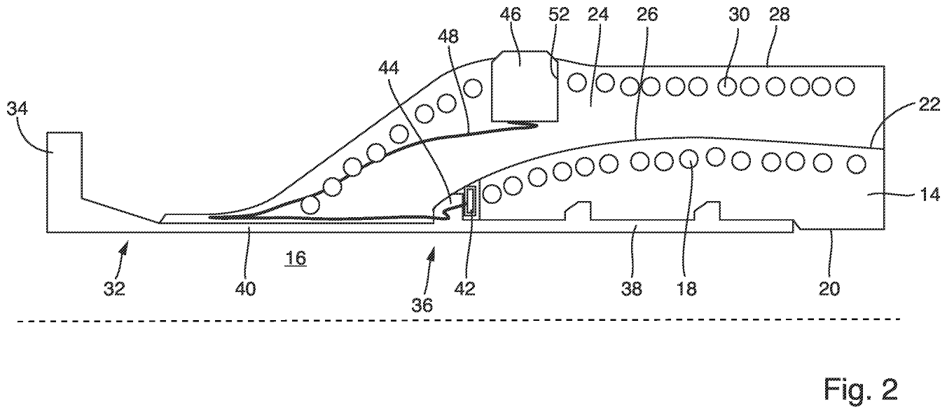

FIG. 2 shows a part of the first end of an exemplary embodiment of a floating hose segment according to the invention in cross-section, and

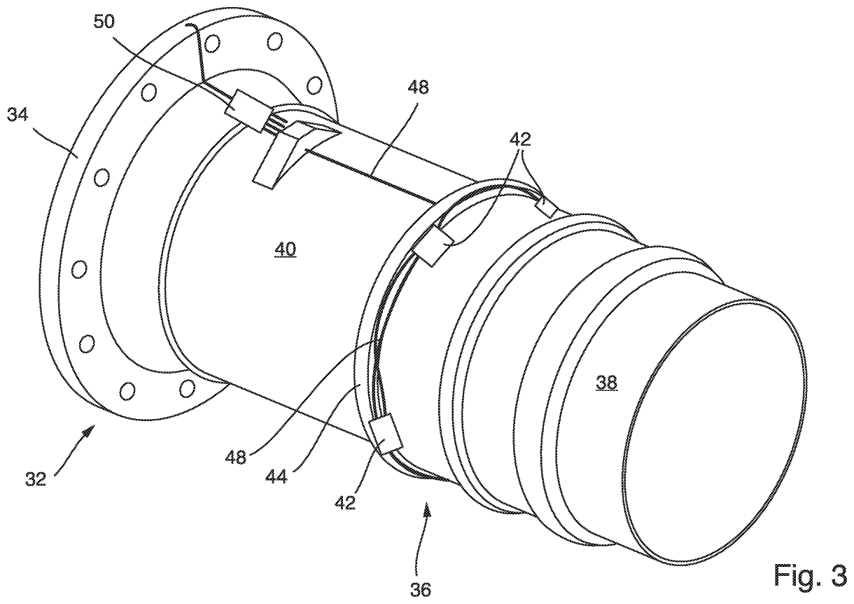

FIG. 3 shows a perspective illustration of the connection element of the first end of an exemplary embodiment of a floating hose segment according to the invention with the sensor devices in a perspective illustration.

As can be seen in FIG. 1, the preferred exemplary embodiment of a floating hose system 2 according to the invention has a multiplicity of floating hose segments 4 which are joined to one another in a row such that a chain of floating hose segments 4 is formed which extends between a first chain end 6 and second chain end 8. The individual floating hose segments 4 here each have a first end 10 and a second end 12 and in each case a first end 10 of a floating hose segment 4 is detachably joined to a second end 12 of a further floating hose segment 4.

The individual floating hose segments 4 are designed such that they float on the surface of a body of water such as, for example, the surface of the ocean, wherein this floatability can be achieved in different fashions. The material of the floating hose segments 4 can be selected such that the specific weight of the floating hose segment as a whole is less than that of the water such that a sufficient buoyancy takes effect. It is, however, also possible that air chambers which likewise provide buoyancy are formed in the floating hose segments 4. The floating hose segments 4 forming the floating hose system 2 can thus be formed in different fashions such that they float and do not sink into the water under their dead weight.

The structure of the individual floating hose segments 4 which are formed according to a preferred exemplary embodiment of the present invention can be seen in particular in FIG. 2.

The floating hose segments 4 are constructed such that they have an inner hose element 14 which is designed with the shape of a hose, such that it has a wall which can be in particular circular in cross-section and surrounds an interior space, wherein the interior space of the inner hose element 14 forms the line region 16 of the floating hose segment 4 through which a fluid such as, for example, oil can be conveyed. The wall of the inner hose element 14 is provided with an inner carcass 18 which has a fabric (illustrated schematically here) and rubber and serves as a reinforcing support of the inner hose element 14. Despite the inner carcass 18, the inner hose element 14 can, however, be elastic in such a way that it can reduce or enlarge its cross-section under pressure from inside or outside.

The inner hose element 14 has a first inner surface 20 which in this case delimits the line region 16, and a first outer surface 22 which faces away from the line region 16.

Moreover, the floating hose segments 4 have an outer hose element 24 which is likewise designed with the shape of a hose with a wall with a cross-section which is circular here. The outer hose element 24 here has a second inner surface 26 which delimits an interior space. The inner hose element 14 is arranged in this interior space and extends parallel to the outer hose element 24 through the latter. As a whole, the inner and the outer hose element 14, 24 extend between the first and second ends 10, 12 of the floating hose segment 4.

In the preferred exemplary embodiment illustrated here of a floating hose segment 4 according to the invention, the second inner surface 26 is, in the normal situation in which both the inner and the outer hose element 14, 24 are undamaged, in contact with the first outer surface 22 but can be lifted off the latter or be shifted with respect to the first outer surface 22. It is, however, also conceivable that also in the normal situation with undamaged hose elements 14, 24, the first outer surface 22 of the inner hose element 14 is spaced apart from the second inner surface 26 of the outer hose element 24 such that an intermediate space is formed between the inner and outer hose elements 14, 24.

In each case, however, liquid penetrating into the region between the hose elements 14, 24 and hence between the first outer surface 22 and the second inner surface 26 can move along this region as far as the ends 10, 12.

The outer hose element 24 moreover has a second outer surface 28 which faces outward away from the inner hose element 14 such that, in the preferred exemplary embodiment shown here, it forms the outer surface of the floating hose segment 4. Lastly, the outer hose element 24 has an outer carcass 30 which likewise has a fabric (illustrated schematically here) and rubber and serves as a reinforcing support of the outer hose element 24. The outer carcass 30 thus prevents, but not definitively, the outer hose element 24 from lifting off from the inner hose element 14 when liquid passes between the hose elements 14, 24 because of a leak in the inner or the outer hose element 14, 24.

The floating hose segment 4 moreover has a first connection element 32 at the first end 10 and a second connection element (not illustrated in FIG. 2) at the second end 12. However, in the exemplary embodiment described here, the second connection element is constructed in a very similar fashion to the first connection element 32, and the inner and the outer hose element 14, 24 are fastened thereto in the same way as to the first connection element 32 such that there is no need to illustrate and describe it in detail.

Each of the connection elements 32 has a coupling section 34 for joining to a further connection element and a pipe section 36 which extends away from the coupling section 34. The coupling section 34 can be designed in particular as a flange, the plane of which runs perpendicularly to the direction of extent of the pipe section 36. As can be seen further in FIG. 2, the inner hose element 14 is fastened to a first section 38 of the pipe section 36, whilst the outer hose element 24 is fastened to a second section 40 of the pipe section 36. The first section 38 and the second section 40 are here arranged one behind the other in the direction of extent of the pipe section 36, and the second section 40 lies closer to the coupling section 34 than the first section 38.

As can be seen further in FIGS. 2 and 3, sensor devices 42 are provided which, in the preferred exemplary embodiment described here, are attached to the pipe section 36 of the first connection element 32 between the first section 38 and the second section 40. The sensor devices 42 are here spaced apart around the circumference of the pipe section 36. The sensor devices 42 are thus arranged and adapted such that they are capable of detecting the presence of at least one substance in the region between the hose elements 14, 24 and thus between the first outer surface 22 and the second inner surface 26. Because a multiplicity of sensor devices 42 are provided, it is ensured that the presence of the questionable substance is reliably detected.

In the exemplary embodiment described here, the sensor devices 42 are adapted to detect the presence of salt water and hydrocarbons as the questionable substance. The sensitivity to hydrocarbons ensures that oil penetrating into the region between the hose elements 14, 24 because of a leak in the inner hose element 14 is detected, whilst a leak in the outer hose element 24 can be detected because of the sensitivity to salt water.

As can be seen further in FIGS. 2 and 3, the pipe section 36 has a radially projecting circumferential rib 44 which is arranged between the first section 38 and the second section 40 in the direction of extent of the pipe section 36, wherein the sensor devices 42 are arranged on that side of the rib 44 which faces the first section 38. Simple mounting and positioning of the sensor devices 42 is enabled by the rib 44 before the hose elements 14, 24 are attached to the pipe section 36.

It can moreover be seen in FIG. 2 that a communication device 46 is provided which is here linked to the sensor devices 42 via a cable 48, wherein it is, however, also conceivable that the sensor devices 42 and the communication device 46 are wirelessly linked to each other. A connector 50 can also, as shown in FIG. 3, be interposed in the cable link between the sensor devices 42 and the communication device 46. In the exemplary embodiment shown in FIG. 2, the communication device 46 is accommodated in a recess 52 in the outer hose element 24, wherein the recess 52 extends from the second outer surface 28 into the outer hose element 24. The communication device 46 is thus readily accessible from outside. The cables 48 for interlinking the sensor devices 42 and the communication device run, on the one hand, between the outer hose element 24 and the second section 40 of the pipe section 36 and, on the other hand, through the outer hose element 24 into the recess 52. It is, however, also conceivable that the cables 48 run directly through the outer hose element 24 into the recess 52. Moreover, as indicated in FIG. 3 by the course of the cable, the communication device can also be attached outside the hose elements.

The sensor devices 42 are linked to the communication device 46 such that information which relates to the presence of the questionable substance, i.e. here salt water and/or hydrocarbons, between the first outer surface 22 and the second inner surface 26 can be transmitted to the communication device 46. The communication device 46 is moreover adapted to transmit this information to a central control device 54. In the exemplary embodiment illustrated in FIG. 1 of a floating hose system 2 according to the invention, the central control device 54 is attached to a buoy 56 to which the first chain end 6 is connected. It is, however, also conceivable that the central control device is attached to one of the floating hose segments 4.

The transmission of the information can here take place from the communication devices 46 of the floating hose segments 4 in each case directly wirelessly to the central control device 54. It is, however, also possible that the information is transmitted to the central control device 54 with the interposition of one or more further communication devices 46. Lastly, it is also possible that the control device 54 and the communication devices 46 are linked via cables.

The above described exemplary embodiment of a floating hose system 2 according to the invention works as follows.

If a leak occurs in the inner hose element 14 such that, for example, oil passes from the line region 16 into the region between the first outer surface 22 and the second inner surface 26, this oil is detected by means of the sensor devices 42 which are in contact with this region and are sensitive for hydrocarbons. As a result, a signal is generated which is transmitted from the sensor device 42 to the communication device 46 and is emitted from the latter onward to the central control device 54. The latter can take place either directly or indirectly with the interposition of further communication devices 46.

As a result, a fault message in the form of the sensor signal that oil has penetrated into the region between the hose elements 14, 24 can then already be communicated to the central control device when no oil has yet passed from the line region 16 into the surroundings. It is thus possible to take measures already at an early point in time which prevent such an escape, for example to replace the defective floating hose segment 4 in the floating hose system.

A very analogous procedure is followed if a leak has occurred in the outer hose element 24 such that salt water penetrates into the region between the hose elements 14, 24. This too can be detected at an early point in time with the aid of the sensor device 42, in particular before the inner hose element 14 also becomes damaged because of the leak in the outer hose element 24 and possibly also begins to leak.

As a whole, the floating hose system 2 according to the invention with the floating hose segments 4 likewise according to the invention enables leaks to be detected already at an early point in time and countermeasures to be taken before the actual damage happens.

### LIST OF REFERENCE SIGNS

2 floating hose system
4 floating hose segment
6 first chain end
8 second chain end
10 first end
12 second end
14 inner hose element
16 line region
18 inner carcass
20 first inner surface
22 first outer surface
24 outer hose element
26 second inner surface
28 second outer surface
30 outer carcass
32 first connection element
34 coupling section
36 pipe section
38 first section
40 second section
42 sensor device
44 rib
46 communication device
48 cable
50 connector
52 recess
54 central control device
56 buoy

1.-15. (canceled)

16. A floating hose segment comprising:
an inner hose element (14) which has the shape of a hose and has a first inner surface (20) which delimits a line region (16) through which a fluid such as, for example, oil can be conveyed, and a first outer surface (22) which faces away from the line region (16),
an outer hose element (24) which has the shape of the hose and has a second inner surface (26) which delimits an interior space through which the inner hose element (14) extends, and a second outer surface (28) which faces outward away from the inner hose element (14), and
at least one communication device (46) which is adapted to transmit information directly or indirectly to a central control device (54),
wherein the inner and the outer hose element (14, 24) extend between a first end (10) and a second end (12) of the floating hose segment (4),
wherein at least one sensor device (42) is provided, wherein the at least one sensor device (42) is arranged and adapted so as to be capable of detecting the presence of at least one substance in the region between the first outer surface (22) and the second inner surface (26),
wherein the at least one sensor device (42) is linked to the communication device (46) such that information relating to the presence of the at least one substance between the first outer surface (22) and the second inner surface (26) can be transmitted to the communication device (46), and
wherein the communication device (46) is adapted to transmit the information relating to the presence of the at least one substance between the first outer surface (22) and the second inner surface (26) to the central control device (54).

17. The floating hose segment of claim 16, wherein the at least one sensor device (42) is adapted to detect the presence of salt water as the at least one substance.

18. The floating hose segment of claim 16, wherein the at least one sensor device (42) is adapted to detect the presence of hydrocarbons as the at least one substance.

19. The floating hose segment of claim 16, wherein the floating hose segment (4) further comprises a first connection element (32) at the first end (10) and a second connection element at the second end (12),
wherein each connection element (32) has a coupling section (34) for joining to a further connection element (32) and a pipe section (36) which extends away from the coupling section (34),
wherein at each connection element (32), the inner hose element (14) is fastened to a first section (38) of the pipe section (36) and the outer hose element (24) is fastened to a second section (40) of the pipe section (36), wherein the second section (40) is closer to the coupling section (34) than the first section (38).

20. The floating hose segment of claim 19, wherein the at least one sensor device (42) is attached to the pipe section (36) of the first connection element (32) between the first section (38) and the second section (40).

21. The floating hose segment of claim 20, wherein a multiplicity of sensor devices (42) is attached to the pipe section (36) of the first connection element (32) between the first section (38) and the second section (40), wherein the sensor devices (42) are spaced apart around the circumference of the pipe section (36).

22. The floating hose segment of claim 21, wherein the pipe section (36) has a radially projecting circumferential rib (44) which is arranged between the first section (38) and the second section (40), and
wherein at least one of the sensor devices (42) is arranged on the side of the rib (44) which faces the first section (38).

23. The floating hose segment of claim 22, wherein the at least one sensor device (42) is linked to the communication device (46) by means of a cable (48) which runs between the outer hose element (24) and the second section (40) of the pipe section (36).

24. The floating hose segment of claim 16, wherein the at least one sensor device (42) is linked to the communication device (46) via a cable (48) which extends through the outer hose element (24).

25. The floating hose segment of claim 16, wherein the communication device (46) is accommodated in a recess (52) in the outer hose element (24), and
wherein the recess (52) extends from the second outer surface (28) into the outer hose element (24).

26. The floating hose segment of claim 24, wherein the cable (48) extends through the outer hose element (24) into the recess (52).

27. The floating hose segment of claim 16, wherein the communication device (46) is designed for wireless communication in order to transmit information relating to the presence of the at least one substance between the first outer surface (22) and the second inner surface (26) wirelessly to a further communication device (46) or to the central control device (54).

28. The floating hose segment of claim 16, wherein the inner hose element (14) has an inner carcass (18) and/or the outer hose element (24) has an outer carcass (30).

29. The floating hose segment of claim 16,
wherein the first and second ends (10, 12) of different floating hose segments (4) are joined to each other in such a way that they form a chain of floating hose segments (4) which extends between a first chain end (6) and a second chain end (8).

30. The floating hose segment of claim 29, wherein the system further comprises a buoy (56), wherein the buoy (56) has the central control device (54).
